(19) United States
(12) Patent Application Publication
(10) Pub. No.: US 2026/0208387 A1
(43) Pub. Date: Jul. 23, 2026

(54) SAW BLADE COMPRISING CUTTING TEETH WITH ASYMMETRIC CUTTING EDGE

(71) Applicant: NORRA SKOG, Umeå (SE)

(72) Inventor: Magnus LINDGREN, Umeå (SE)

(73) Assignee: NORRA SKOG, Umeå (SE)

(21) Appl. No.: 19/134,921

(22) PCT Filed: Nov. 29, 2023
(86) PCT No.: PCT/SE2023/051202

§ 371 Date: Jun. 2, 2025

(30) Foreign Application Priority Data
Dec. 2, 2022 (SE) 2251409-5

(51) Int. Cl. B27B 33/06; B23D 55/06; B23D 55/08; B23D 61/12

(52) U.S. Cl. CPC B27B 33/06; B23D 55/082; B23D 61/121; B23D 55/065

(57) ABSTRACT

Embodiments of the invention relate to a saw blade for a sawing application. The saw blade comprising: a band and a plurality of cutting teeth arranged along the band for cutting in a material, wherein the plurality of cutting teeth comprise cutting teeth having an asymmetric cutting edge so that a lateral cutting force acting on the saw blade when the saw blade is cutting in the material is biased in a lateral direction of the saw blade. Furthermore, embodiments of the invention also relate to a band saw comprising such a saw blade.

### TECHNICAL FIELD

Embodiments of the invention relate to a saw blade comprising cutting teeth with asymmetric cutting edge. Furthermore, embodiments of the invention also relate to a band saw comprising such a saw blade.

### BACKGROUND

Band saws are a type of saws used in different sawing applications. A saw blade of the band saw comprises a plurality of cutting teeth for cutting in a material. Examples of sawing applications for band saws are woodworking, metalworking and lumbering.

Band saws are commonly powered by an electrical motor arranged to drive one or more powered wheels between which the saw blade is arranged so as to cut in the material. The number of wheels and the configuration of the wheels may e.g., depend on the load distribution, the material to be cut, etc.

Different configurations of band saws are horizontal bandsaws, circular bandsaws and band saw for sawing lines. The latter application is often used in sawmill plants for producing planks and boards out of wood.

### SUMMARY

An objective of embodiments of the invention is to provide a solution which mitigates or solves the drawbacks and problems of conventional solutions.

The above and further objectives are solved by the subject matter of the independent claims. Further embodiments of the invention can be found in the dependent claims.

According to a first aspect of the invention, the above mentioned and other objectives are achieved with a saw blade for a sawing application, the saw blade comprising:
a band; and
a plurality of cutting tooths arranged along the band for cutting in a material, wherein the plurality of cutting teeth comprise cutting teeth having an asymmetric cutting edge so that a lateral cutting force acting on the saw blade when the saw blade is cutting in the material is biased in a lateral direction of the saw blade.

Thus, the saw blade when cutting in the material will be inclined to drift in one of the lateral directions of the saw blade e.g., the left direction or right direction in relation to a cutting direction of the saw blade, due to the biased lateral cutting force. Hence, the lateral cutting forces of the present saw blade will not be balanced and instead larger in one of the lateral directions, hence biased. This means that the present saw blade will drift in its lateral/side direction if no biasing device is arranged for counteracting the biased lateral cutting force and thus balance the lateral cutting force generated by the cutting teeth having asymmetric cutting edges. Without any such biasing device the saw blade will continuously drift in one of the lateral directions when cutting in the material.

An advantage of the saw blade according to the first aspect is that the saw blade will not move back and forth in the lateral directions of the saw blade when cutting in the material since the saw blade is configured to drift in one lateral direction only. This means a cleaner cut compared to conventional solutions if the biased lateral cutting force is balanced. Thereby, the saw blade can also be made thinner compared to the conventional saw blades implying reduced weight and production cost.

In an implementation form of a saw blade according to the first aspect, a sum of the lateral cutting forces generated by the plurality of cutting teeth is biased in the lateral direction.

In an implementation form of a saw blade according to the first aspect, the saw blade is biased to drift in the lateral direction of the saw blade when the saw blade is cutting in the material.

In an implementation form of a saw blade according to the first aspect, the lateral direction is directed perpendicularly outwards from the extension of the band.

The lateral cutting force thus comprises a force component which is perpendicular to an extension of the band.

In an implementation form of a saw blade according to the first aspect, the asymmetric cutting edge comprises at least one angled cutting section extending partially or fully along the cutting edge, wherein the angled cutting section is angled in relation to a cutting direction of the cutting tooth.

In an implementation form of a saw blade according to the first aspect, the asymmetric cutting edge comprises a first angled cutting section and a second angled cutting section, wherein an angle of the first angled cutting section is different to an angle of the second angled cutting section.

In an implementation form of a saw blade according to the first aspect, the asymmetric cutting edge comprises at least one radial cutting section extending partially or fully along the cutting edge, wherein the radial cutting section is radial in relation to a cutting direction of the cutting tooth.

In an implementation form of a saw blade according to the first aspect, the asymmetric cutting edge comprises a first radial cutting section and a second radial cutting section, wherein a radius of the first radial cutting section is different to a radius of the second radial cutting section.

In an implementation form of a saw blade according to the first aspect, the asymmetric cutting edge comprises at least one angled cutting section and at least one radial cutting section.

In an implementation form of a saw blade according to the first aspect, the plurality of cutting teeth comprise cutting teeth having an asymmetric radial clearance so that the lateral cutting force acting on the saw blade when the saw blade is cutting in the material is biased in the lateral direction.

In an implementation form of a saw blade according to the first aspect, the asymmetric radial clearance comprises a first radial clearance angle and a second radial clearance angle different to the first radial clearance angle.

In an implementation form of a saw blade according to the first aspect, the plurality of cutting teeth comprise cutting teeth having an asymmetric tangential clearance so that the lateral cutting force acting on the saw blade when the saw blade is cutting in the material is biased in the lateral direction.

In an implementation form of a saw blade according to the first aspect, the asymmetric tangential clearance comprises a first tangential clearance angle and a second tangential clearance angle different to the first tangential clearance angle.

According to a second aspect of the invention, the above mentioned and other objectives are achieved with a band saw for sawing in a material, the band saw comprising:
a first saw blade according to any embodiments of the invention; and
a first biasing arrangement configured to bias the first saw blade in a first lateral direction of the first saw blade, and wherein the first saw blade comprises first cutting teeth configured to bias the first saw blade in the first lateral direction or a second lateral direction of the first saw blade when cutting in the material, the second lateral direction being opposite to the first lateral direction.

An advantage of the band saw according to the second aspect is a cleaner cut compared to conventional band saws since the bias of the biasing arrangement can be balanced by the herein disclosed saw blade. In conventional solutions the saw blade moves back and forth between the two lateral directions when cutting in the material resulting in a less clean cut and increased wear.

In an implementation form of a band saw according to the second aspect, the band saw further comprises:
a second saw blade according to any embodiments of the invention; and
a second biasing arrangement configured to bias the second saw blade in the second lateral direction of the second saw blade, and wherein the second saw blade comprises second cutting teeth configured to bias the second saw blade in the first lateral direction of the second saw blade when cutting in the material.

In an implementation form of a band saw according to the second aspect, the first saw blade and the second saw blade are aligned to each other in the band saw, and wherein the first lateral direction and the second lateral direction are directed outwards from the material in operation.

In an implementation form of a band saw according to the second aspect, the material is wood.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a section of a saw blade in a view from above according to embodiments of the invention;

FIGS. 2 and 3 illustrate a cutting tooth having an angled cutting section according to embodiments of the invention;

FIGS. 4 and 5 illustrate a cutting tooth having an angled cutting section and/or a radial cutting section according to embodiments of the invention;

FIGS. 6 and 7 illustrate a cutting tooth having radial cutting sections according to embodiments of the invention;

FIG. 8 illustrates radial clearance and tangential clearance;

FIG. 9 illustrate a cutting tooth having asymmetric radial clearance and/or asymmetric tangential clearance according to embodiments of the invention; and

FIGS. 10 and 11 illustrate a band saw according to embodiments of the invention.

### DETAILED DESCRIPTION

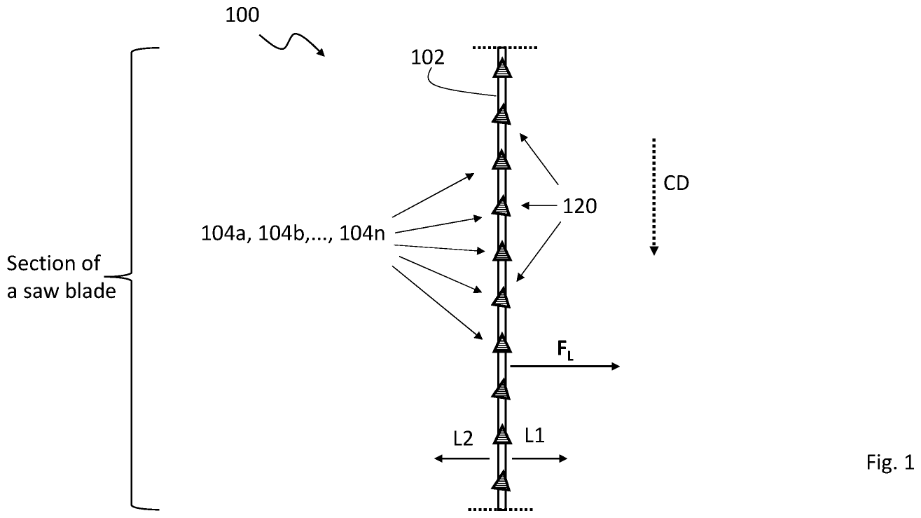

FIG. 1 shows a section of a saw blade 100 for a sawing application according to embodiments of the invention. The herein disclosed saw blade 100 comprises a band 102 and a plurality of cutting teeth 104a, 104b, . . . , 104n which are arranged along the band 102 for cutting in a material 300. The plurality of cutting teeth may be arranged at an edge of the band 102 and be arranged equidistantly on the blade 102 edge as shown in FIG. 1. However, the layout of the cutting teeth on the blade 110 is not limited thereto.

According to embodiments of the invention, the plurality of cutting teeth 104a, 104b, . . . , 104n comprise cutting teeth having an asymmetric cutting edge 120 so that a lateral cutting force F_{L} acting on the saw blade 100 when the saw blade 100 is cutting in the material 300 is biased in one lateral direction L1, L2 of the saw blade 100. The lateral cutting force F_{L} may also be seen as a side force acting on the cutting tooth and thus on the whole saw blade 100 when the cutting teeth are cutting in the material 300. Generally, the resultant cutting force acting on a cutting tooth when cutting in the material comprises of three force components, i.e., a main force also called cutting force, a normal force which is related to the feed of the tooth and a lateral force which is perpendicular to the main force and the normal force. Thus, the lateral cutting force F_{L} comprises a force component which is perpendicular to an extension of the band 110. This also implies that the lateral direction L1, L2 is directed perpendicularly outwards from the extension of the band 102 as shown in FIG. 1. The extension of the band 102 may be considered in parallel to the cutting direction.

Thereby, the saw blade 100 when cutting in the material 300 will be biased to drift or so to speak move in one of the two lateral directions L1, L2 of the saw blade 100 in operation. Conventional, it is desired that a saw blade is operating in a straight line without biased lateral drift and a number of solutions have been proposed in the art in this respect. However, the present solution instead discloses cutting teeth having asymmetric cutting edges so that the saw blade 100 drifts in one of its two lateral directions L1, L2 thereby possibly providing an oblique or a curved cutting line if not compensated for. Thus, the sum of the lateral cutting forces F_{S} generated by the plurality of cutting teeth will be biased in one lateral direction. The sum of the lateral cutting forces F_{S} may be considered as the resultant lateral cutting force when the plurality of cutting teeth cut in the material 300.

It may further be noted that not all the cutting teeth of the saw blade 100 have to comprise asymmetric cutting edges even though that may be the case. In the non-limiting example in FIG. 1 every second cutting tooth have asymmetric cutting edge and every second cutting tooth have symmetric cutting edge and the band saw 100 will still be biased in one of its lateral directions. The symmetric cutting edges are configured to make the band saw 100 operate in a straight line along the cutting direction (CD) of the saw blade 100. However, since the present saw blade 100 comprises cutting teeth with asymmetric cutting edges, the saw blade 100 will drift in one of two lateral directions when cutting in a material 300. The ratio of cutting teeth with asymmetric cutting edges to cutting teeth with symmetric cutting edges may be a design option depending on the desired amount of lateral drift of the saw blade 100. Other parameters and configurations will also affect the amount of lateral drift such as the type of asymmetric cutting edge and the configuration of the asymmetric cutting edge which will be described in the following disclosure.

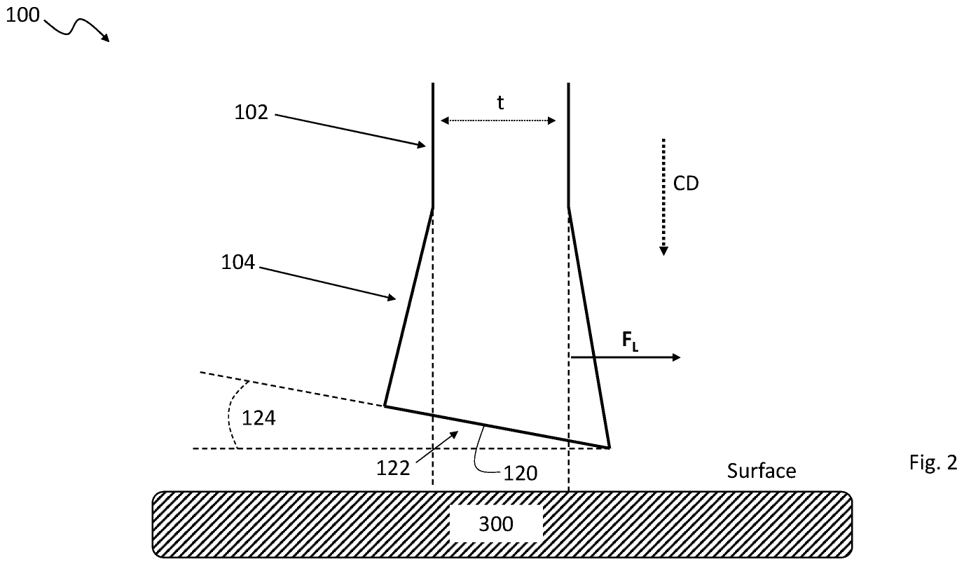

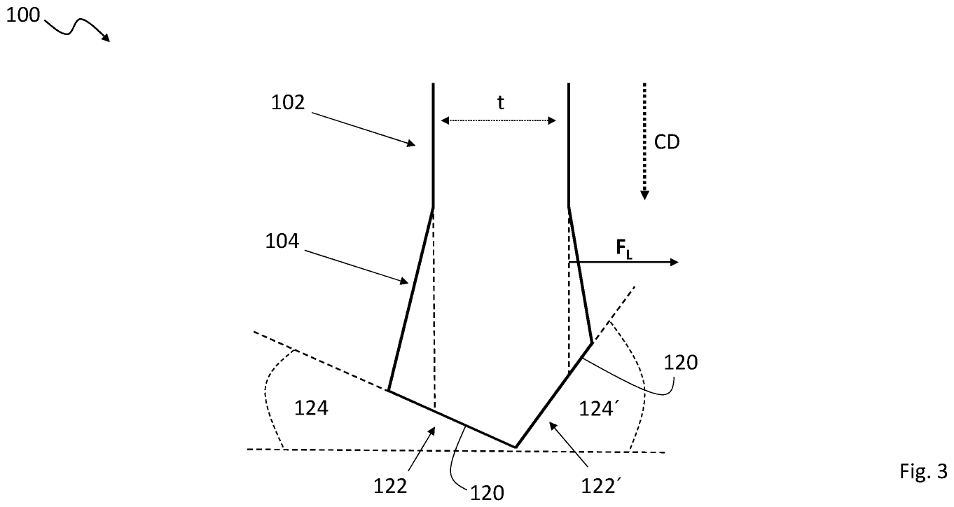

Thus, FIGS. 2 and 3 illustrate a cutting tooth 104 having an angled cutting section 122 according to embodiments of the invention. The angled cutting section 122 is an example of the invention an asymmetric cutting section to achieve the desired lateral drift of the saw blade 100. In this example the asymmetric cutting edge 120 comprises at least one angled cutting section 122, 122′ extending partially (FIG. 3) or fully (FIG. 2) along the cutting edge 120. The angled cutting section 122, 122′ is angled in relation to a plane perpendicular to the extension of the band 102 and also to the cutting direction of the cutting tooth when cutting in the material 300. Hence, the angled cutting section 122, 122′ is also angled in relation to a surface of the material 300 to be cut. The surface may be considered as an imaginary plane of the material 300.

Furthermore, in embodiments of the invention, the asymmetric cutting edge 120 comprises a first angled cutting section 122 and a second angled cutting section 122′. In these examples, the angle 124 of the first angled cutting section 122 is different to the angle 124′ of the second angled cutting section 122′ as shown in FIG. 3. Hence, the first angled cutting section 122 and the second angled cutting section 122′ together form the asymmetric cutting edge 120.

The angles of the angled cutting section 122, 122′ will affect the size of the lateral force acting on the saw blade 100 and therefore the degree or amount of drift of the saw blade 100. Generally, the larger the angle the larger the lateral cutting force acting on the cutting tooth and hence on the saw blade 100. Thus, when the angle increases the lateral cutting force also increases. In a non-limiting example, the angle 124, 124′ of the angled cutting section 122, 122′ may be an angle between 1 to 45 degrees or in other examples between 5 to 25 degrees.

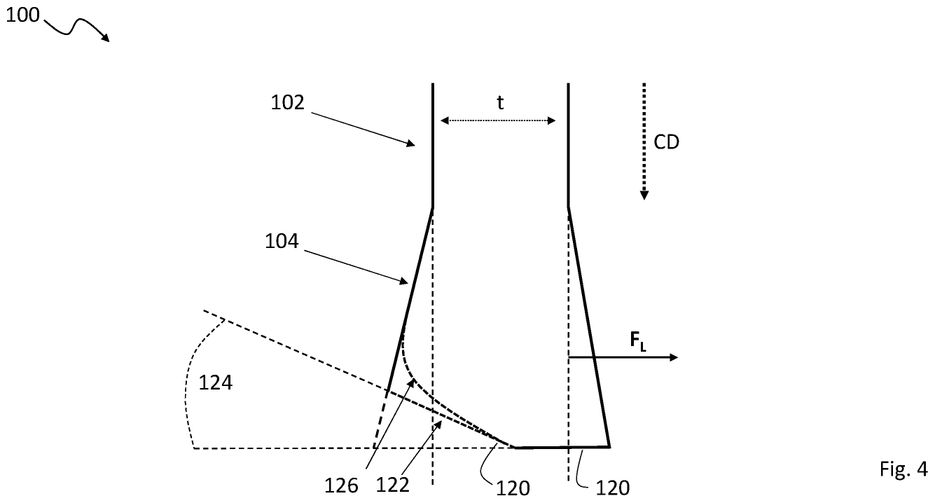

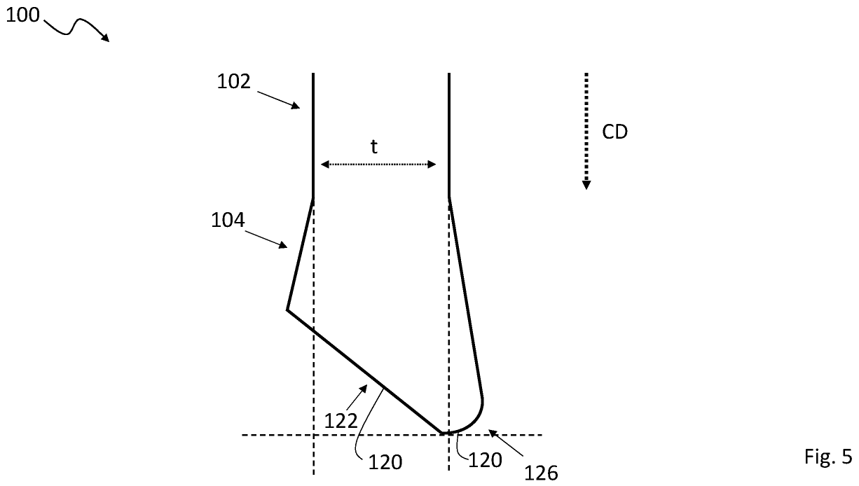

Moreover, FIGS. 4 and 5 illustrate a cutting tooth 104 having an angled cutting section 122 and/or a radial cutting section 126 according to embodiments of the invention. FIG. 4 illustrates the example when the cutting edge 120 either comprises an angled cutting section 122 or a radial cutting section 126 which extends partially along the cutting edge 120 of the cutting tooth 104. FIG. 5 on the other hand shows a cutting tooth having an asymmetric cutting edge 120 formed from an angled cutting section 122 and a radial cutting section 126. It may be noted that the radial cutting sections in FIGS. 4 and 5 have a convex shape.

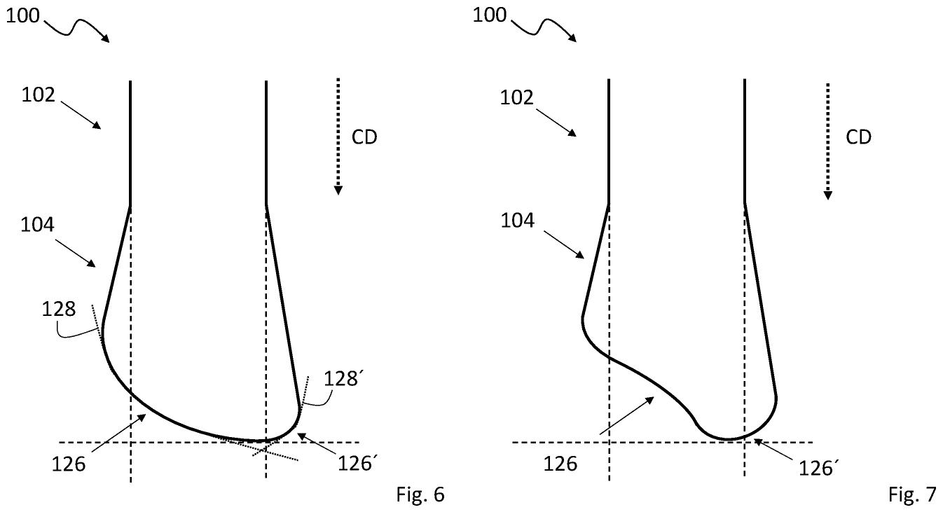

FIGS. 6 and 7 illustrate further examples of a cutting tooth 104 having radial cutting sections 126 according to embodiments of the invention. As shown in FIGS. 6 and 7 the asymmetric cutting edge 120 comprises at least one radial cutting section 126, 126′ extending partially or fully along the cutting edge 120. The radial cutting section 126, 126′ forms a radius of the cutting edge of the cutting tooth. The asymmetric cutting edge 120 may be formed from a first radial cutting section 126 and a second radial cutting section 126′ such that a radius 128 of the first radial cutting section 126 is different to a radius 128′ of the second radial cutting section 126′.

The radial cutting section may have a convex shape or a concave shape depending on the application. Thus, FIG. 6 shows the example when two different convex radial cutting edges form the asymmetric cutting edge 120 while FIG. 7 instead shows the example when a concave radial cutting edge (left section) and a convex radial cutting edge (right section) together form the asymmetric cutting edge 120. Any combinations of convex and concave cutting edges are also possible.

It should be noted that the plurality of cutting teeth may comprise cutting teeth having angled cutting section and/or radial cutting section.

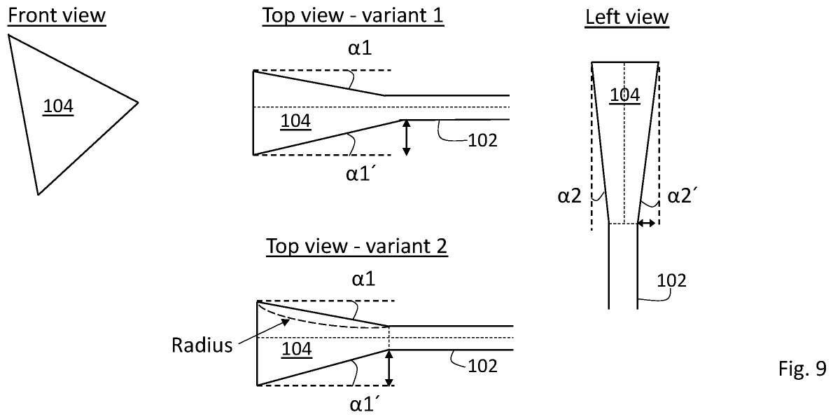

FIG. 9 illustrate a cutting tooth 104 having asymmetric radial clearance and/or asymmetric tangential clearance according to embodiments of the invention. The asymmetric radial clearance and the asymmetric tangential clearance are other ways of achieving the lateral drift of the saw blade 100 when cutting in the material 300. Thus, asymmetric clearance can be combined with angled cutting edge and radial cutting edge. In an example, a cutting tooth 104 may have any one of: angled cutting edge, radial cutting edge, asymmetric radial clearance and/or asymmetric tangential clearance. Hence, all these different configurations comprising asymmetric cutting teeth will affect the lateral drift of the saw blade 100.

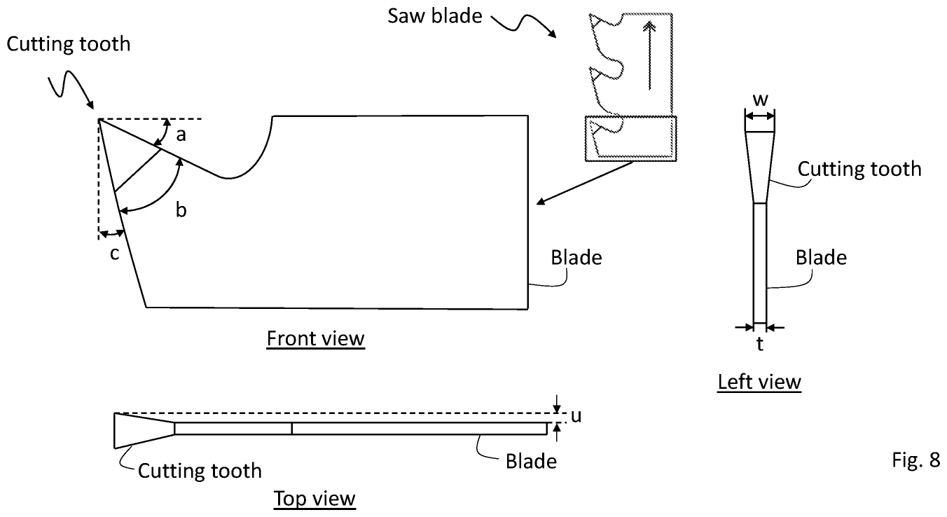

To understand the radial clearance and the tangential clearance of a cutting tooth FIG. 8 shows a front view, a top view and a left view of a cutting tooth in a sectional view of a saw band in a tooth movement corresponding to the previous mentioned cutting direction. It is to be noted that the cutting tooth shown in FIG. 8 has symmetric radial clearance and tangential clearance. The cutting tooth is arranged on a band and the band has a width t that is less than the width w of the cutting tooth as seen in the top view and the left view. With reference to the front view in FIG. 8, “a” denotes the rake angle, “b” the wedge angle and “c” the clearance angle, respectively. Further, the top view shows “u” which is the clearance of the cutting tooth.

FIG. 9 however illustrates asymmetric radial clearance and asymmetric tangential clearance according to embodiments of the invention. The radial clearance and the tangential clearance make up the side faces of the cutting tooth 104. The radial clearance angle and the tangential clearance angle needs to be sufficient to leave room for the elastic spring-back of the material to be cut such as when cutting in wood. This means that the plurality of cutting teeth 104a, 104b, . . . , 104n may comprise cutting teeth having an asymmetric radial clearance and/or asymmetric tangential clearance so that the lateral cutting force FL acting on the saw blade 100 when the saw blade 100 is cutting in the material 300 is biased in one of the lateral directions L1, L2 of the saw blade 100 for lateral drift.

More particularly, the asymmetric radial clearance may comprise a first radial clearance angle α1 and a second radial clearance angle α1′ different to the first radial clearance angle α1 which is illustrated in two variants in the top view of FIG. 9. Variants 1 and 2 shown in the top view illustrate that the cutting tooth 104 may be formed by two different radial clearance angles α1, α1′ thus providing asymmetric cutting teeth by different clearance angles. Correspondingly, the asymmetric tangential clearance may comprise a first tangential clearance angle α2 and a second tangential clearance angle α2′ different to the first tangential clearance angle α2 as shown in the left view in FIG. 9. It may be noted that the angles of the radial clearance and the tangential clearance may depend on the application e.g., on the desired lateral drift, the material to be cut, etc. A non-limiting angle range for the radial clearance and the tangential clearance may be between 1 to 40 degrees or between 1 to 10 degrees e.g., for wood working applications. Generally, the lateral cutting force is larger the smaller the angle of clearance and thus the relation between the lateral cutting force and angle of clearance is inverse.

What is further illustrated in variant 2 in FIG. 9 is the example when the radial clearance may be a clearance radius instead of a clearance angle illustrated with the dashed line and marked “radius” in FIG. 9. Therefore, in embodiments of the invention the asymmetric radial clearance and/or the asymmetric tangential clearance may also be obtained or represented with different clearance radiuses. The clearance radius may further be combined with a clearance angle to achieve the desired asymmetry of the cutting tooth 104.

The tooth geometry may e.g., be formed from a suitable material using computer numerical control (CNC) laser or CNC water jet cutters. However, the cutting tooth or parts of the cutting tooth may in other examples be attached to the band or to a part forming the base of a cutting tooth using any suitable technique. The material from which the cutting tooth is produced may be of any suitable kind such as steel, carbide or bimetal. The saw blade 100 can be used for cutting in wood, aluminum, brass, bronze, copper, lead, zinc, graphite, fiberglass, plastic, cork, non-ferrous metals, etc.

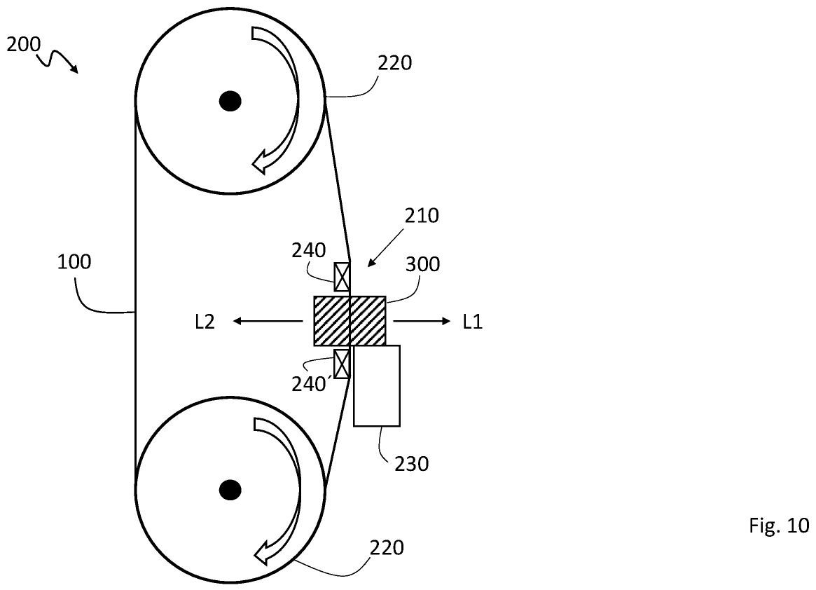

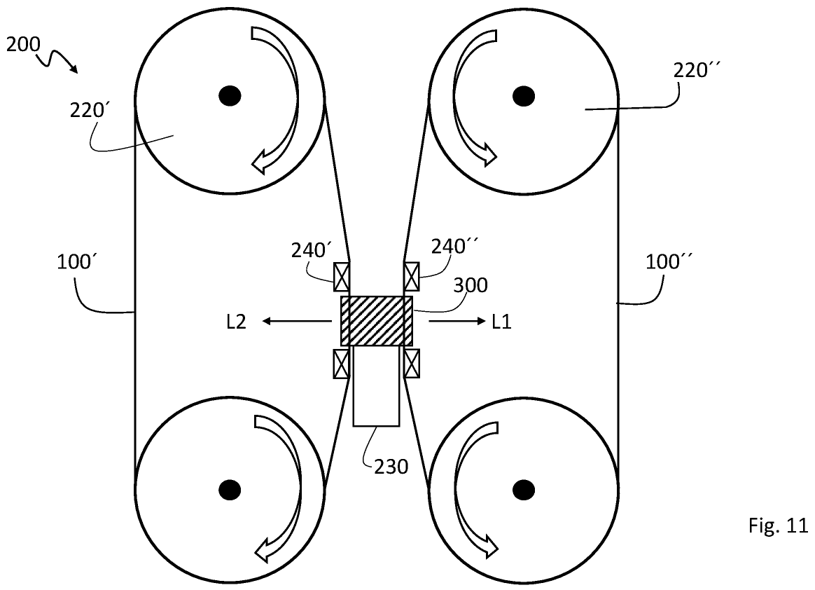

Moreover, FIGS. 10 and 11 illustrate a band saw 200 according to embodiments of the invention. The herein disclosed band saw 200 comprises at least one saw blade according to embodiments of the invention. The band saw 200 further comprises a first biasing arrangement 210, 210′ configured to bias a first saw blade 100, 100′ in a first lateral direction L1 of the first saw blade 100. As shown in FIGS. 10 and 11 the biasing arrangement 210, 210′ may comprise of two blocks 240, 240′ configured to press the first saw blade 100, 100′ in a lateral direction opposite to the lateral direction to which the first saw blade 100, 100′ is biased when cutting in the material 300, i.e., in the second lateral direction L2. The blocks 240, 240′ are arranged on each side of the section of the material 300 to be cut so that that the first saw blade 100, 100′ therebetween forms a straight line for a clean straight cut in the material 300. Thus, the amount of lateral force generated by the biasing arrangement may be balanced to the lateral force for which the first saw blade 100, 100′ is configured.

The first saw blade 100, 100′ is further driven/powered by two or more wheels 220, 220′ between which the first saw blade 100, 100′ is arranged. At least one of the wheels 220, 220′ may be powered for driving the first saw blade 100. Usually, a powered wheel is driven by an electric motor (not shown in the Figs.) of the band saw 200. The band saw 200 further comprises a support device 230 for supporting the material 300 in the right position when cut by the first saw blade 100, 100′.

The first saw blade 100, 100′ comprises first cutting teeth configured to bias the first saw blade 100, 100′ in a second lateral direction L2 of the first saw blade 100, 100′ when cutting in the material 300. The second lateral direction L2 is opposite to the first lateral direction L1. By balancing the lateral bias of the first biasing arrangement 210, 210′ with the lateral bias of the first saw blade 100, 100′, the first saw blade 100, 100′ is configured to cut in the material 300 with a clean cut in a straight line. It may however be noted that the first saw blade 100, 100′ may in other examples be configured to drift in the first lateral direction L1, i.e., in the same lateral direction as the direction which the blocks 240, 240′ press the first saw blade 100, 100′.

Moreover, for sawing applications when two or more parallel sawing lines are cut at the same time, band saws with two or more saw blades are needed. For example, in a sawmill for sawing planks or boards from wood or timber in one sequence at least two saw blades are needed as shown in FIG. 11. Hence, the band saw 200 in such embodiments further include at least one second saw blade 100″ according to embodiments of the invention. The band saw 200 may also comprise a second biasing arrangement 210″ configured to bias the second saw blade 100″ in the second lateral direction L2 of the second saw blade 100″. The second saw blade 100″ comprises second cutting teeth configured to bias the second saw blade 100″ in the first lateral direction L1 of the second saw blade 100″ when cutting in the material 300. By aligning the first saw blade 100′ and the second saw blade 100″ to each other with a distance d in the band saw 200, the first lateral direction L1 and the second lateral direction L2 will be directed outwards from the material 300 in operation.

Finally, it should be understood that the invention is not limited to the embodiments described above, but also relates to and incorporates all embodiments within the scope of the appended independent claims.

1. A saw blade for a sawing application, the saw blade comprising:
a band; and
a plurality of cutting teeth arranged along the band for cutting in a material, wherein the plurality of cutting teeth comprise cutting teeth having an asymmetric cutting edge so that a lateral cutting force acting on the saw blade when the saw blade is cutting in the material is biased in a lateral direction of the saw blade.

2. The saw blade according to claim 1, wherein a sum of the lateral cutting forces generated by the plurality of cutting teeth is biased in the lateral direction.

3. The saw blade according to claim 1, or wherein the saw blade is biased to drift in the lateral direction of the saw blade when the saw blade is cutting in the material.

4. The saw blade according to claim 1, wherein the lateral direction is directed perpendicularly outwards from the extension of the band.

5. The saw blade according to claim 1, wherein the asymmetric cutting edge comprises at least one angled cutting section extending partially or fully along the cutting edge, wherein the angled cutting section is angled in relation to a cutting direction of the cutting tooth.

6. The saw blade according to claim 5, wherein the asymmetric cutting edge comprises a first angled cutting section and a second angled cutting section, wherein an angle of the first angled cutting section is different to an angle of the second angled cutting section.

7. The saw blade according to claim 1, wherein the asymmetric cutting edge comprises at least one radial cutting section extending partially or fully along the cutting edge, wherein the radial cutting section is radial in relation to a cutting direction of the cutting tooth.

8. The saw blade according to claim 7, wherein the asymmetric cutting edge comprises a first radial cutting section and a second radial cutting section, wherein a radius of the first radial cutting section is different to a radius of the second radial cutting section.

9. The saw blade according to claim 1, wherein the asymmetric cutting edge comprises at least one angled cutting section and at least one radial cutting section.

10. The saw blade according to claim 1, wherein the plurality of cutting teeth comprise cutting teeth having an asymmetric radial clearance so that the lateral cutting force acting on the saw blade when the saw blade is cutting in the material is biased in the lateral direction.

11. The saw blade according to claim 10, wherein the asymmetric radial clearance comprises a first radial clearance angle and a second radial clearance angle different to the first radial clearance angle.

12. The saw blade according to claim 1, wherein the plurality of cutting teeth comprise cutting teeth having an asymmetric tangential clearance so that the lateral cutting force acting on the saw blade when the saw blade is cutting in the material is biased in the lateral direction.

13. The saw blade according to claim 12, wherein the asymmetric tangential clearance comprises a first tangential clearance angle and a second tangential clearance angle different to the first tangential clearance angle.

14. A band saw for sawing in a material, the band saw comprising:
a first saw blade including
a band; and
a plurality of cutting teeth arranged along the band for cutting in a material, wherein the plurality of cutting teeth comprise cutting teeth having an asymmetric cutting edge so that a lateral cutting force acting on the saw blade when the saw blade is cutting in the material is biased in a lateral direction of the saw blade; and
a first biasing arrangement configured to bias the first saw blade in a first lateral direction of the first saw blade, and wherein the first saw blade comprises first cutting teeth configured to bias the first saw blade in the first lateral direction or a second lateral direction of the first saw blade when cutting in the material, the second lateral direction being opposite to the first lateral direction.

15. The band saw according to claim 14, further comprising:
a second saw blade including
a band; and
a plurality of cutting teeth arranged along the band for cutting in a material, wherein the plurality of cutting teeth comprise cutting teeth having an asymmetric cutting edge so that a lateral cutting force acting on the saw blade when the saw blade is cutting in the material is biased in a lateral direction of the saw blade; and
a second biasing arrangement configured to bias the second saw blade in the second lateral direction of the second saw blade, and wherein the second saw blade comprises second cutting teeth configured to bias the second saw blade in the first lateral direction of the second saw blade when cutting in the material.

16. The band saw according to claim 15, wherein the first saw blade and the second saw blade are aligned to each other in the band saw, and wherein the first lateral direction and the second lateral direction are directed outwards from the material in operation.
